(19) United States
(12) Patent Application Publication
(10) Pub. No.: US 2021/0159933 A1
(43) Pub. Date: May 27, 2021

(54) MOBILE DEVICE COVER WITH IMPACT ABSORPTION STRUCTURE

(71) Applicants: Jack Dufelmeier, Chicago, IL (US); Nelson Li, Shenzhen (CN); Aatish Patel, Boston, MA (US)

(72) Inventors: Jack Dufelmeier, Chicago, IL (US); Nelson Li, Shenzhen (CN); Aatish Patel, Boston, MA (US)

(21) Appl. No.: 17/103,456

(22) Filed: Nov. 24, 2020

Related U.S. Application Data
(60) Provisional application No. 62/940,047, filed on Nov. 25, 2019.

(51) Int. Cl. H04B 1/3888

(52) U.S. Cl. CPC H04B 1/3888

(57) ABSTRACT

Disclosed herein is a multi-layer case for a portable electronic device such as a smartphone, the case including an impact cushioning layer between the well for receiving the portable electronic device and an outer layer, the impact absorbing layer including a plurality of spaced apart pillars that compress or deflect to absorb impact. The pillars may be of any convenient cross-section, and the cross-section may be tailored to flex or compress in a particular way.

### BACKGROUND OF THE INVENTION

### Field of the Invention

The present patent application relates to protective cases or covers used with portable electronic devices, such as smart phones. More specifically, the application relates to cases which include structures in the case to improve the shock or impact protection provided by the case to the portable electronic device.

### Background Art

Electronic device covers and encasements designed to be placed over or around the manufactured enclosure that contains the electronics and forms part of the external surfaces of the device, have been around for many years. The cases or covers typically provide protection for the devices in the event that the devices are dropped or subject to other types of impacts. Increased protection is desirable for devices that may be subject to harsh conditions or environments where impacts are more likely, or for users that drop their devices more frequently.

The impact protection of cases or covers is related to the selection of the materials used to make the case. Some cases are constructed entirely of materials such as TPU to provide impact resistance or protection. Other polymers having a softness or cushion may also be used. Other cases use a combination of materials to achieve a desired level of impact resistance, such as the two piece cases that utilize a hard shell over a soft or cushion layer, or in the alternative, a soft outer layer over a harder inner shell. These layers may be separate pieces, or co-molded of formed into a single unitary case or cover. In yet other cases, three layers may be used, the case including a hard outer shell over a soft middle layer, which in turn is over a hard inner shell. The added layers often add to the weight of the case, which becomes both bulky and heavier with each layer.

Other cases include areas of increased thickness to provide additional protection. One such case is a product marketed by Incipio which includes thicker case walls at the corners of the case. https://incipio.com/cases/iphone-cases/iphone-xs-cases/reprieve-sport-iphone-xs-case.html. While such constructions have the advantage of increased protection, they add bulk at the corners and provide bumps that may not be aesthetically pleasing. Further, the bumps may snag and make placing a removing the phone from a pocket difficult.

### SUMMARY OF THE INVENTION

Disclosed herein is an electronic device cover or case that includes structures to provide impact resistance and protection to a mobile electronic device. The structures are a plurality of pillars, filaments, protrusions, bumps, or other structures with space between them to allow for deflection or expansion of the material when it is compressed during impact.

Disclosed herein is a new filament shock or impact absorption design which implements an impact energy dissipation layer, effectively creating a crumple zone, to mobile device protection cases. The shock absorption or impact absorption design can be implemented using three layers: an outer layer shell, a layer of polymer filaments or pillars, and an interior layer shell. It is preferred that the outer layer shell is harder than the filament layer so as to spread the impact energy to filaments around the impact point or area. In other embodiments, the case may omit the interior shell layer.

The middle layer of polymer filaments serves as the effective crumple zone in this design. These filaments can be elastic, uniformly-aligned, circular cross-section, truncated cones that deform omnidirectionally to dissipate energy equally regardless of impact angle. The filaments may also deflect in all directions about a primary axis to also dissipate energy and absorb impact to the outer shell. The truncated geometry allows for greater stresses towards the outer surface due to smaller cross-sectional area of the filaments near the impact surface which then enables deformation and deflection to dissipate the impact energy away from the surface closest to the device being protected.

In other embodiments, other filament profiles may be used, such as filaments or pillars with oval, triangular, polygonal, or irregular cross sections may be used. Further, the filaments do not need to be tapered or conical. It is preferred that the spacing between filaments is at least half the diameter of the filaments. Such spacing allows for deflection and expansion of the filaments influenced by any impact.

In other embodiments, some of the filaments are shorter than others. Such shorter filaments do not extend from the outer shell to the inner shell. Such filaments do not absorb or contribute to the impact resistance until the outer shell is deformed sufficiently to compress or deflect the filament.

One of the many benefits of this design from a consumer's point of view is that it provides the user with superior level shock absorption without the previously needed bulky, heavy design. Since impact forces almost primarily are experienced on the corners and side walls of a phone, this design specifically protects these target areas by placement of a plurality of filaments or pillars and allows for a case sidewall thickness that is thinner than other impact protection cases. The placement of the impact absorption structures on the sidewalls allows for extremely thin backwall thickness that is unprecedented for heavy shock-absorbing mobile devices. In some embodiments, the backwall may be eliminated. In other embodiments, the impact absorption pillars may be included in the back wall construction as well. Additionally, the columnar middle layer presents a construction with less material that traditional mobile device designs, which enables this case to provide much lighter-weight protection that previously possible.

Prior art attempts at improving mobile device shock absorption and impact protection have been focused at the material level, which often lead to higher costs at the consumer's expense. This approach is novel in that it focuses on the design construction, where the low cost materials traditionally used in mobile device protection can be utilized in a new, superior way without costing the consumer more money.

Compared to designs with exposed structures (either external facing or device facing), the design used in the invention offers advantages. First, with the impact structure being an internal feature (in between an out and inner layer), the structure is protected from damage, wear, and debris which may impeded upon on the impact performance of the structure.

Another advantage of the proposed design disclosed herein is superior distribution of energy or load during an impact event. In a design with an external structure, that is one without a shell to spread an impact load over an area, the structures interface first with whatever is being impacted upon. Each individual structure takes the load of the impact, absorbing the energy. While this works to improve impact resistance, the structures themselves are individually exposed to very high levels of energy, which can lead to failure if levels are excessive or exceed the structures ability to absorb or deflect the impact.

In the invention described, the exterior cover or shell is the first component to interface with the impact object. This cover is supported by the pillar impact structures, and also has a larger surface area for impact. Because of this, during impact the load is transferred first into the larger surface area of the cover, which deforms over a larger area than the point or area of impact, and then into the internal pillar structures beneath the larger area. Load is thus distributed into multiple structures, which helps dissipate the impact energy in a more efficient manner.

In one form, the invention is directed to a case for a portable electronic device. The case includes at least two layers, the first layer being an outer layer and the second layer being a layer positioned between a well of the case and the first layer. The second layer includes a plurality of pillars. The pillars extend from a surface of the second layer toward the outer layer. The pillars are capable of compression and deflection.

In one form, the pillars are of uniform cross-section.

In one form, at least some of the pillars extend to and touch the outer layer.

In one form, the pillars are of non-uniform cross-section.

In one form, the pillars have a base and a top. The pillars are wider at the base than at the top.

In one form, the pillars are spaced apart from one another by a distance of at least half of a pillar diameter measured at the base of the pillar.

In one form, the pillars have a base and a top. The pillars are narrower at the base than at the top.

In one form, the invention is directed to a case for a portable electronic device which includes an impact absorbing structure. The structure has a plurality of spaced apart pillars extending from a surface of the impact absorbing structure. Some of the pillars touch an exterior shell layer of the case.

In one form, the pillars can deflect in a lateral direction.

In one form, the pillars can compress. The pillars are of a narrower cross section between a pillar top and a pillar base.

In one form, the pillars are of uniform cross-section from a pillar base to a pillar top.

In one form, the pillars are of non-uniform cross section from pillar base to pillar top. The concentration of the pillars is not uniform across the impact absorbing layer.

In one form, the pillars are non-uniformly spaced apart from each other.

In one form, the invention is directed to a case for a portable electronic device. The case includes an impact absorbing layer positioned between an outer shell of the case and a well for receiving a portable electronic device. The impact absorbing layer has a plurality of structures that compress and deflect. The structures extend from a surface of the impact absorbing layer. The structures each have an axis in the direction in which they extend. The structures each have a cross-section about the structure's axis.

In one form, the structures have the same cross-section.

In one form, the structures each have a top and a base. A structure has a uniform cross-section from the top to the base.

In one form, the structures each have a top and a base. A structure has a non-uniform cross-section from the top to the base.

In one form, the structures have a top. The top of at least one structure is in contact with the outer shell of the case.

In one form, the structures vary in height.

In one form, the structures have a top. The top deflects a lateral distance of at least 5% of the thickness of the impact absorbing layer.

### BRIEF DESCRIPTION OF THE DRAWINGS

FIG. 1 is a perspective view of a three-piece electronic device case of the invention.

FIG. 2 is a perspective view of the outer shell or layer of the electronic device case of the invention.

FIG. 3 is a perspective view of the middle cushion layer with pillars, of the three-piece electronic device case of the invention.

FIG. 4 is a perspective view of the inner layer of the electronic device case of the invention.

FIG. 5 is a side profile diagram of a pillar, showing omni-directional deflection.

FIG. 6 is a top view diagram of a pillar, showing omni-directional deflection.

FIG. 7A is a back view of a three-piece case

FIG. 7B is a cross-sectional view of a three-piece case.

FIG. 8 is a perspective view of a two-piece electronic device case of the invention.

FIG. 9 is a perspective view of the outer shell or layer of the electronic device case of the invention.

FIG. 10 is a perspective view of the cushion layer with pillars, of the two-piece electronic device case of the invention.

FIG. 11A is a back view of a two-piece case.

FIG. 11B is a cross-sectional view of a two-piece case.

FIG. 12 is a perspective view of an assembled case.

FIG. 13 is a front view of an assembled case.

FIG. 14 is a top view of an assembled case

FIG. 15 is a right side view of an assembled case.

FIG. 16 is a partial cross sectional view of a corner of a three-piece case having pillars of polygonal cross-section.

FIG. 17 is a partial cross sectional view of a corner of a three-piece case having pillars of rectangular cross-section.

FIG. 18 is a partial cross sectional view of a corner of a three-piece case having pillars of uniform cross section.

FIG. 19 is a partial cross sectional view of a corner of a three-piece case having pillars of non-uniform cross-section, the top being wider than the base.

FIG. 20 is a partial cross sectional view of a corner of a three-piece case having pillars of non-uniform cross-section, the base being wider than the top.

### DETAILED DESCRIPTION OF THE PREFERRED EMBODIMENT

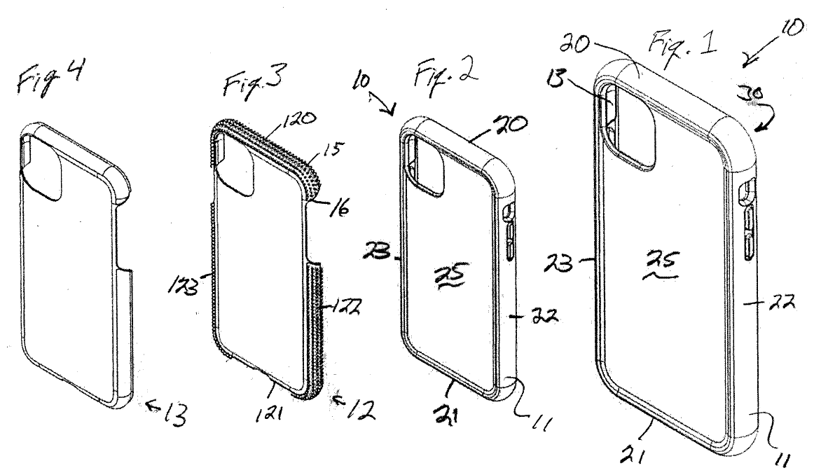

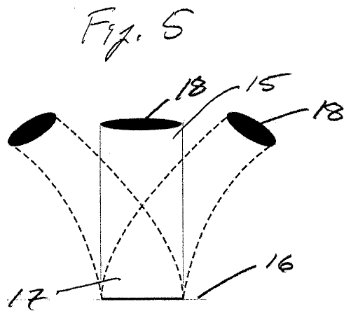

With reference to the figures, FIG. 1 is an exemplary illustrative view of the electronic device case 10 of the present invention. The case shown in FIG. 1 is a three-piece case including an outer shell 11, a middle cushion layer 12, and an inner layer 13. The case 10 or cover is understood to be one that goes over and is supplemental to the encasement or case that encloses the electronics of the electronic device as provided by a commercial manufacturer. However, the added features described herein could be applied to the manufacturer's encasement.

The case 10 generally includes a top wall 20, a bottom wall 21, and two opposing side walls 22 and 23, thereby forming a space or well 30 between the walls for the portable electronic device. In some embodiments, the case may include a back wall 25 spanning the top 20, bottom 21, and two opposing side walls 22 and 23 to form a well 30 for receiving of the portable electronic device.

The outer shell 11 may include a top wall 20, a bottom wall 21, and two opposing side walls 22 and 23. The outer shell 11 is preferably made of TPU, TPE or other material that is hard and will spread the load of impact. In some embodiments, the outer material is selected to be one that flexes greater than 5% of the material thickness.

The middle layer 12 also may include the top wall 121, a bottom wall 122, and two opposing side walls 122 and 123. In general, the middle layer 12 acts to space the outer shell 11 from the inner layer 13. The middle layer 12 may be co-extensive with the outer layer or shell 11, or it may exist only in specific areas. The middle layer 12 also provides impact absorption or cushioning. It is preferable the middle layer 12 be made of silicone, rubber, or other materials that may compress to absorb the impact. It is also preferable that the material of the middle layer be capable of the deflection. In some embodiments, the middle layer deflects or flexes to at least 5% of the material thickness. In some embodiments, the middle layer 12 is a composed of a plurality of layers, each layer having a different impact absorption property. For instance, the middle layer 12 may have a first layer that flexes more than the underlying layer of the middle layer.

In some embodiments of the invention, the middle layer 12 includes a plurality of protrusions, filaments, pillars 15, or other structures extending from its surface 16 towards the outer shell 11 or inner layer 13 of the case 10. The pillars 15 each extend along an axis. It is most preferable to have the pillars 15 extend towards the outer shell 11. It is preferable to have at least some of the pillars 15 contact the outer shell 11, but it is not necessary. Structures other than the pillars 15 may be used to maintain the spaced apart relation of the outer shell 11 and inner layer 13 or electronic device.

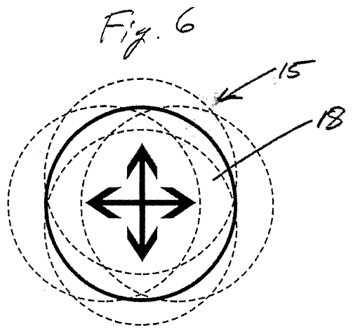

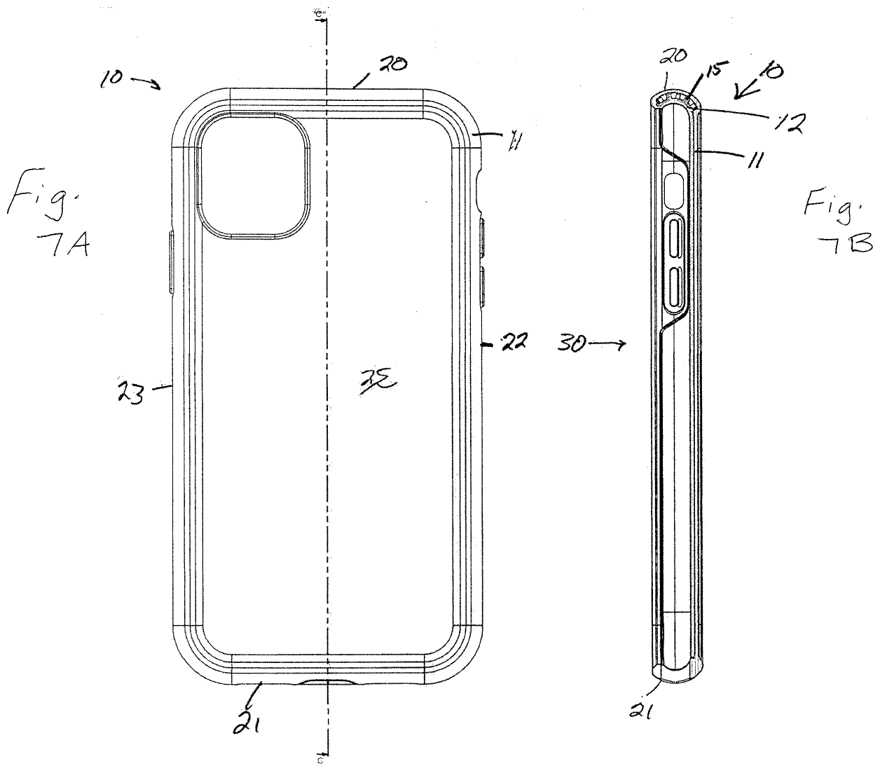

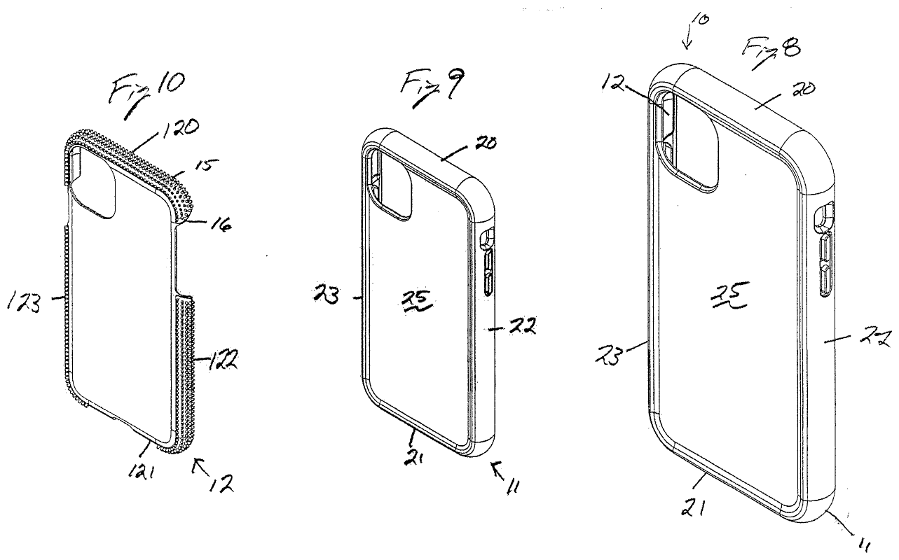

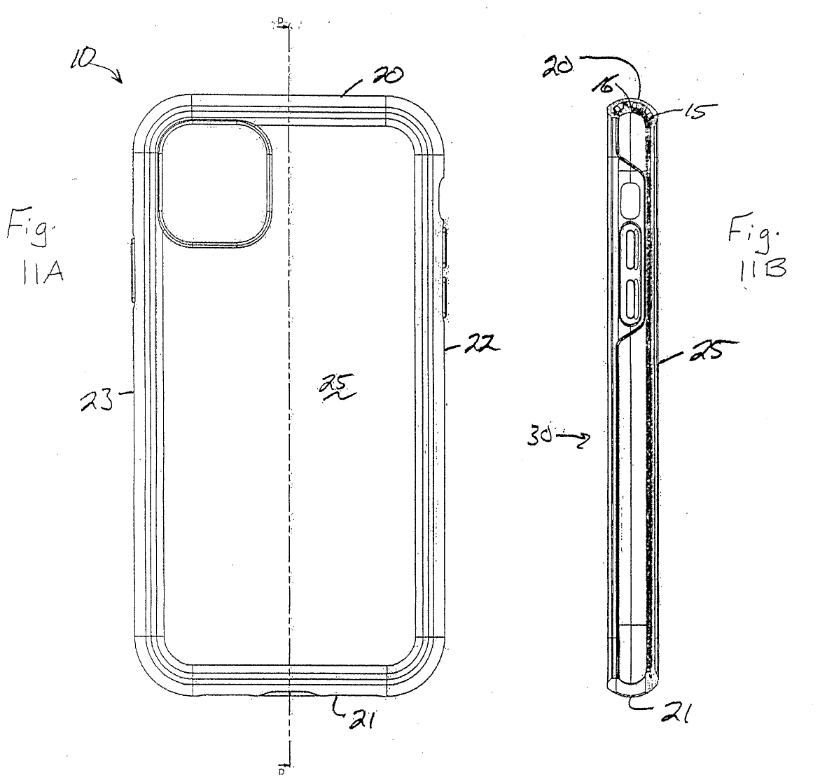

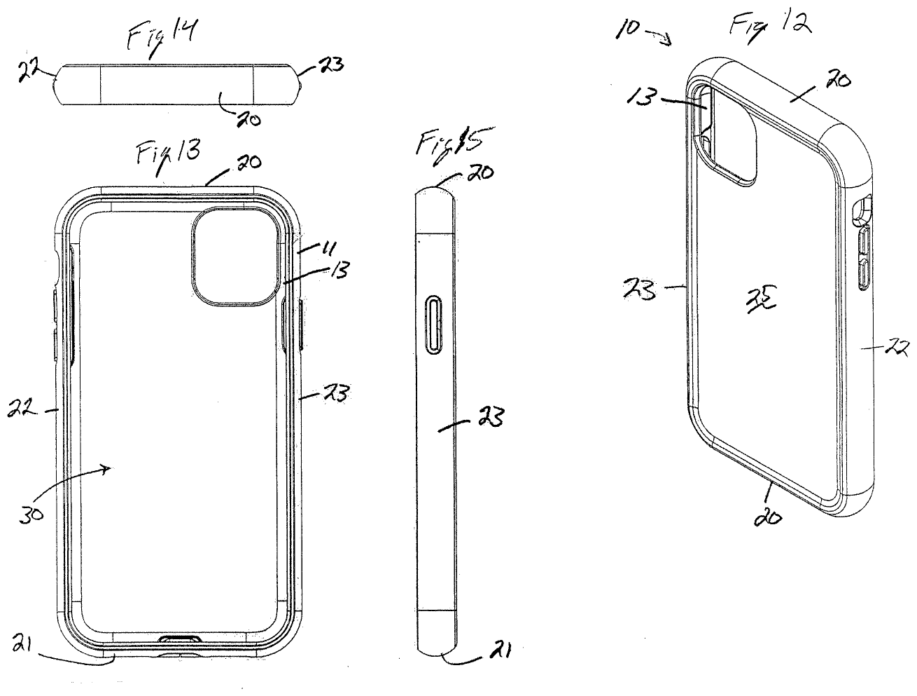

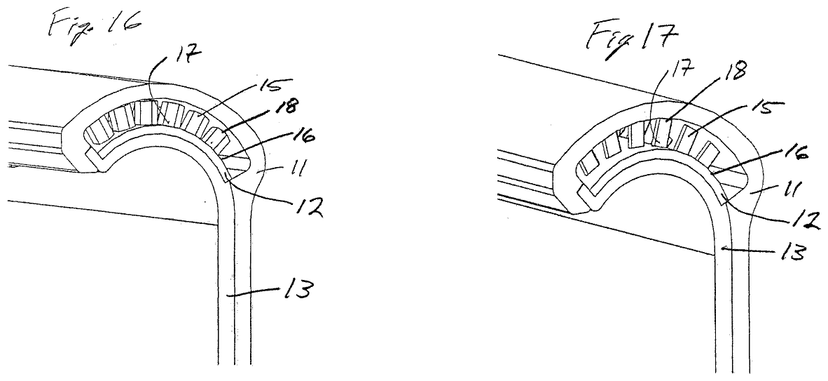

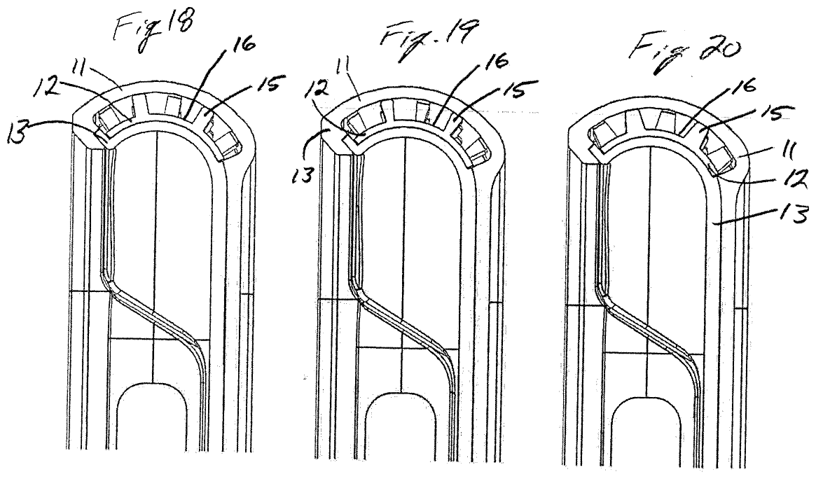

In some embodiments, the pillars 15 are truncated conical structures spaced apart from one another by at least half their diameter of the base of the structure or pillar 15. The space between the pillars 15 allow the pillars 15 to not only expand when compressed, but also deflect from side to side or laterally in as many directions as possible to absorb impact, as shown in FIGS. 5 and 6. In some embodiments, the pillars 15 may be wider at the base 17 than at the top 18, and as such do not have a uniform cross-section about the axis of the pillar. In other embodiments, the pillars are wider at the top than at the base. In other embodiments, the pillars 15 are uniform in cross section about the axis. It will be recognized that the pillars 15 in any one case 10 may be a combination of any of the variations described herein.

The pillars 15 are generally evenly distributed on the outer surface of the middle layer 12. In some embodiments, the concentration of pillars 15 may be increased or decreased to achieve different levels of impact protection. Similarly, the material used to create the pillars 15 may vary by location on the case 10. For instance, the concentration of pillars 15 or the material of the pillars 15 may be different at the corners of the case 10 when compared to the sides of the case 10 in order to provide more protection to the corners of the portable electronic device.

The pillars 15 may be of different cross-sectional shapes, such a columnar, oval, triangular, polygonal, and irregular shapes. The shapes may also vary from pillar 15 to pillar 15. For instance, it may be desirable to use an oval shape pillar 15 in an area where greater impact resistance is desired in one axis of deflection than in another. In such an embodiment, the major axis of the oval would be aligned with the direction of the desired greater impact resistance. A rectangular pillar 15 may have a similar result.

The pillars 15 may also vary in height. In some embodiments, some of the plurality of pillars 15 are displaced some distance from the outer shell 11. This may be described as being shorter than the other pillars 15.

1. A case for a portable electronic device, the case including at least two layers, the first layer being an outer layer and the second layer being a layer positioned between a well of the case and the first layer, the second layer including a plurality of pillars, the pillars extending from a surface of the second layer toward the outer layer, the pillars being capable of compression and deflection.

2. The case of claim 1, wherein the pillars are of uniform cross-section.

3. The case of claim 1, wherein at least some of the pillars extend to and touch the outer layer.

4. The case of claim 1 wherein the pillars are of non-uniform cross-section.

5. The case of claim 1 wherein the pillars have a base and a top, and the pillars are wider at the base than at the top.

6. The case of claim 1 wherein the pillars are spaced apart from one another by a distance of at least half of a pillar diameter measured at the base of the pillar.

7. The case of claim 1 wherein the pillars have a base and a top, and the pillars are narrower at the base than at the top.

8. A case for a portable electronic device, the case including an impact absorbing structure, the structure including a plurality of spaced apart pillars, the pillars extending from a surface of the impact absorbing structure, some of the pillars touching an exterior shell layer of the case.

9. The case of claim 8, wherein the pillars can deflect in a lateral direction.

10. The case of claim 9 wherein the pillars can compress and are of a narrower cross section between a pillar top and a pillar base.

11. The case of claim 8 wherein the pillars are of uniform cross-section from a pillar base to a pillar top.

12. The case of claim 8 wherein the pillars are of non-uniform cross section from pillar base to pillar top, and the concentration of the pillars is not uniform across the impact absorbing layer.

13. The case of claim 8, wherein the pillars are non-uniformly spaced apart from each other.

14. A case for a portable electronic device, the case including an impact absorbing layer positioned between an outer shell of the case and a well for receiving a portable electronic device, the impact absorbing layer having a plurality of structures that compress and deflect, the structures extending from a surface of the impact absorbing layer, the structures each having an axis in the direction in which they extend, the structures each having a cross-section about the structure's axis.

15. The case of claim 14, wherein the structures have the same cross-section.

16. The case of claim 14, wherein the structures each have a top and a base, a structure having a uniform cross-section from the top to the base.

17. The case of claim 14 wherein the structures each have a top and a base, a structure having a non-uniform cross-section from the top to the base.

18. The case of claim 14, wherein the structures have a top, the top of at least one structure being in contact with the outer shell of the case.

19. The case of claim 14, wherein the structures vary in height.

20. The case of claim 14, wherein the structures have a top, the top deflecting a lateral distance of at least 5% of the thickness of the impact absorbing layer.
